(19) United States
(12) Patent Application Publication
(10) Pub. No.: US 2020/0034800 A1
(43) Pub. Date: Jan. 30, 2020

(54) ELECTRONIC RECEIPT SYSTEM

(71) Applicant: TOSHIBA TEC KABUSHIKI KAISHA, Tokyo (JP)

(72) Inventors: Takuya HAKETA, lzunokuni Shizuoka (JP); Masato OISHI, Numazu Shizuoka (JP)

(73) Assignee: TOSHIBA TEC KABUSHIKI KAISHA, Tokyo (JP)

(21) Appl. No.: 16/517,321

(22) Filed: Jul. 19, 2019

(30) Foreign Application Priority Data
Jul. 24, 2018 (JP) 2018-138660

(51) Int. Cl. G06Q 20/04; G06Q 20/20; G06K 19/06

(52) U.S. Cl. CPC G06Q 20/0453; G06K 19/06009; G06Q 20/202

(57) ABSTRACT

An electronic receipt system comprises a first storage module that stores receipt data indicating contents of a transaction in association with a unique management code for specifying the receipt data; a notifying module that provides the unique management code to a target person associated with the transaction; an acquiring module that acquires a member code for specifying an electronic receipt member and a management code input including the unique management code from the electronic receipt member; a second storage module that stores the receipt data stored in the first storage module in association with the unique management code acquired by the acquiring module in association with the member code acquired by the acquiring module; and an output module that outputs a receipt image generated according to the receipt data stored in the second storage module in association with the member code included in a request for an electronic receipt in response to the request.

### CROSS-REFERENCE TO RELATED APPLICATION

This application is based upon and claims the benefit of priority from Japanese Patent Application No. 2018-138660, filed in Jul. 24, 2018, the entire contents of which are incorporated herein by reference.

### FIELD

Embodiments described herein relate generally to an electronic receipt system.

### BACKGROUND

In recent years, a so-called electronic receipt system has been developed and put into practical use to enable an electronic receipt on which contents of a transaction relating to sales of a commodity or provision of service are printed to be viewable on an information terminal.

In a conventional electronic receipt system, at the time of settlement of a transaction, if a member code for specifying a customer registered as an electronic receipt member is presented by the customer, an electronic receipt is issued. If the member code is not presented, the electronic receipt is not issued. The member code is presented via an information terminal such as a smartphone or an Integrated Circuit (IC) card possessed by the customer, for example. Therefore, when a customer forgets the information terminal or the IC card, since he/she cannot present the member code even though he/she is the electronic receipt member, a paper receipt is issued instead of an electronic receipt at the time of settlement of the transaction. After this, no electronic receipt relating to that transaction can be received.

### DESCRIPTION OF THE DRAWINGS

FIG. 1 is a diagram illustrating an overall configuration of an electronic receipt system according to an embodiment;

FIG. 2 is a schematic view illustrating a format of a data record stored in a first database of the electronic receipt system;

FIG. 3 is a schematic view illustrating a format of a data record stored in a second database of the electronic receipt system;

FIG. 4 is a block diagram illustrating a circuit configuration of main components of an electronic receipt server in the electronic receipt system;

FIG. 5 is a schematic view illustrating a configuration of a management table formed in a main memory of the electronic receipt server in the electronic receipt system;

FIG. 6 is a block diagram illustrating a circuit configuration of main components of a Point of Sales (POS) terminal in the electronic receipt system;

FIG. 7 is a schematic view illustrating a main memory area formed in the main memory of the POS terminal in the electronic receipt system;

FIG. 8 is a flowchart depicting procedures of a data processing relating to one transaction performed by a processor of the POS terminal in the electronic receipt system;

FIG. 9 is a flowchart depicting procedures of the data processing relating to one transaction performed by the processor of the POS terminal in the electronic receipt system;

FIG. 10 is a flowchart depicting procedures of a data reception processing performed by a processor of the electronic receipt server in the electronic receipt system;

FIG. 11 is a flowchart depicting procedures of a command reception processing performed by the processor of the electronic receipt server in the electronic receipt system;

FIG. 12 is a flowchart depicting procedures of the command reception processing performed by the processor of the electronic receipt server in the electronic receipt system;

FIG. 13 is a schematic view illustrating an issuance example of a receipt;

FIG. 14 is a schematic view illustrating an issuance example of a receipt with a management number;

FIG. 15 is a schematic view illustrating a management code input image;

FIG. 16 is a flowchart depicting procedures of a data processing relating to one transaction performed by a processor of a POS terminal according to a second embodiment; and

FIG. 17 is a schematic view illustrating a sheet issued after the receipt shown in FIG. 13 according to the second embodiment.

### DETAILED DESCRIPTION

In accordance with an embodiment, an electronic receipt system comprises a first storage module configured to store receipt data indicating contents of a transaction in association with a unique management code for specifying the receipt data; a notifying module configured to provide the management code to a target person who performs the transaction; an acquiring module configured to acquire a member code for specifying an electronic receipt member and a management code input by the electronic receipt member specified by the member code; a second storage module configured to store the receipt data that is stored in the first storage module in association with the management code acquired by the acquiring module in association with the member code acquired by the acquiring module; and an output module configured to output a receipt image generated according to the receipt data stored in the second storage module in association with the member code included in a request for an electronic receipt in response to the request.

Hereinafter, an embodiment of an electronic receipt system capable of receiving an electronic receipt also for past transactions is described with reference to the accompanying drawings.

### First Embodiment

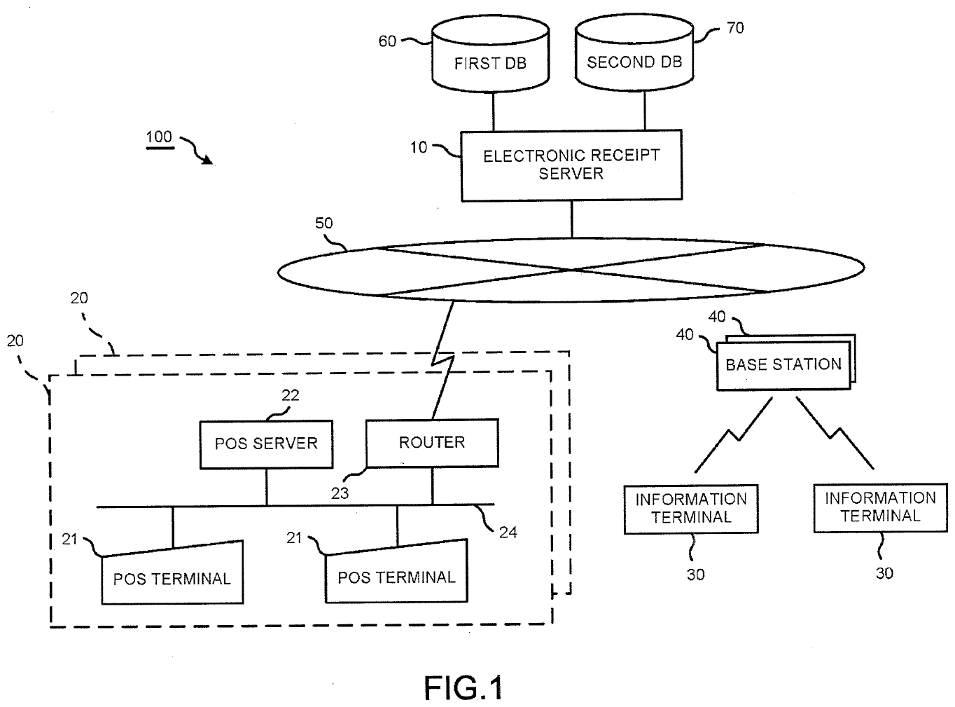

First, a configuration of an electronic receipt system is schematically described with reference to an overall configuration diagram shown in FIG. 1. An electronic receipt system 100 includes an electronic receipt server 10, a plurality of POS systems 20, a plurality of information terminals 30, a plurality of base stations 40, and a wide area network 50. The network 50 connects the electronic receipt server 10, the POS systems 20 and the base stations 40 in a bidirectional data communication manner. The network 50 is, for example, the Internet.

The electronic receipt server 10 performs information processing for providing an electronic receipt service that provides an electronic receipt to a customer who purchases a commodity or a customer who enjoys a service in an existing retail store.

The electronic receipt server 10 has a first database 60 and a second database 70. Details of the first database 60 and the second database 70 are described below. The electronic receipt server 10 may provide an electronic receipt service using a cloud computing system.

The POS system 20 is installed in an existing retail store. A business category of the retail store is not limited. For example, the POS system 20 may be installed in a supermarket, a convenience store, a department store, a drug store, a food store, an apparel store, a home appliance store, a household goods store, a restaurant, and the like.

The POS system 20 includes a plurality of POS terminals 21, a POS server 22, a router 23 and an in-store network 24. The network 24 connects the POS terminals 21, the POS server 22 and the router 23 in a bidirectional data communication manner. The network 24 is, for example, an LAN (Local Area Network).

The POS terminal 21 performs registration processing for registering sales data of a commodity to be purchased by a customer in a memory and settlement processing for receiving a payment amount from the customer based on the registered sales data to settle the transaction. The POS server 22 collectively controls the registration processing and the settlement processing performed by each POS terminal 21. Through the control, the POS server 22 manages sales, inventory and the like of each commodity sold in the retail store. The router 23 connects the network 24 and the network 50 to relay data transmitted and received from the network 24 to the network 50 or from the network 50 to the network 24.

The information terminal 30 is a portable communication device provided with an input device, a display device, a wireless communication unit, and the like. The input device and the display device are typically a touch panel. The wireless communication unit controls wireless communication between the information terminal 30 and the base station 40 in conformity with a wireless communication standard such as Wi-Fi® Technology. Through the control, if the wireless communication between the information terminal 30 and the base station 40 is established, the base station 40 functions as a relay station for connecting the information terminal 30 with the network 50.

The information terminal 30 is used by a so-called electronic receipt member, i.e., a customer who is registered as a member to enjoy the electronic receipt service. The member registration is enabled by installing software necessary to receive the electronic receipt service on the information terminal 30. Hereinafter, the software is referred to as an electronic receipt application. The customer is assigned with a member ID unique to the customer by performing the member registration using the electronic receipt application. The member ID is stored in the memory of the information terminal 30. Then, the member ID stored in the memory is displayed on a top screen at the time the electronic receipt application is started. The member ID is displayed on a display device, for example, in a format of a barcode. The method for outputting the member ID is not limited to the display. If the information terminal 30 has a NFC (Near Field Communication) function which is a near field wireless communication, the member ID may be output through wireless communication.

The information terminal 30 installs a web browser for browsing contents published on the web. Through the web browser, the information terminal 30 can download the contents published on the web by the electronic receipt server 10 and display it on the display device thereof. The contents that the electronic receipt server 10 publishes on the web include an electronic receipt.

The information terminal 30 having such a configuration may be, for example, a smartphone, a tablet terminal, a notebook computer, or the like.

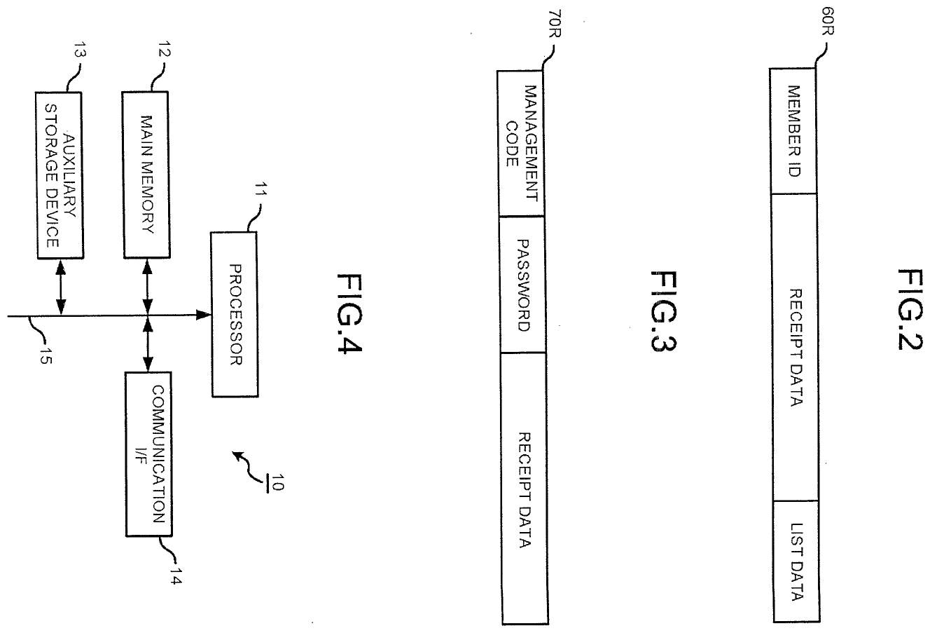

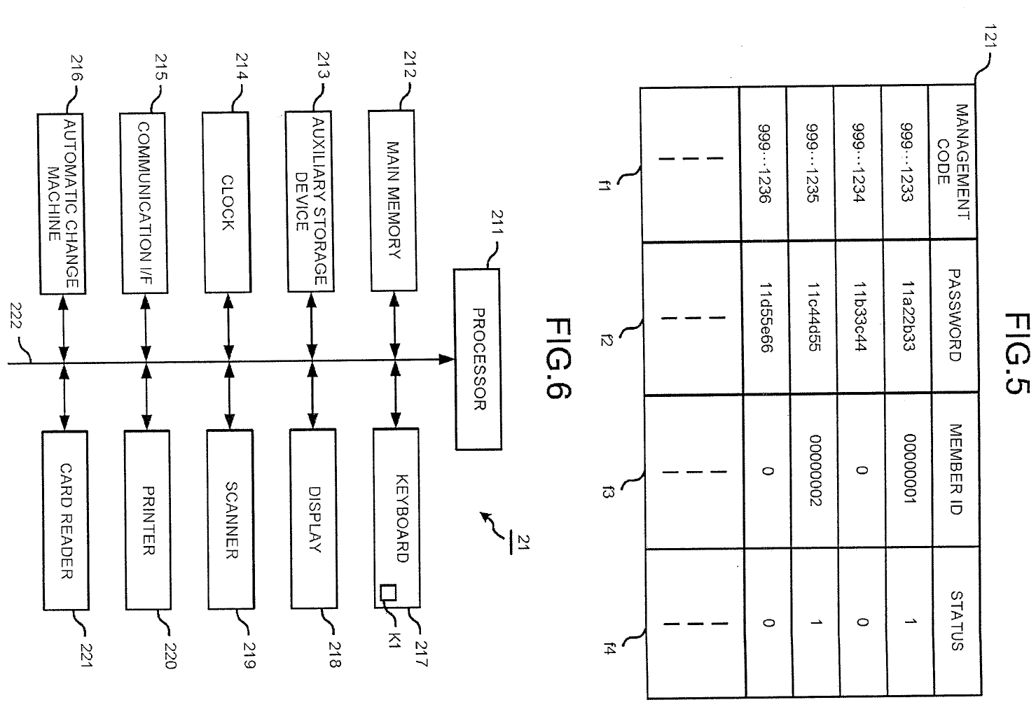

Next, details of the first database 60 and the second database 70 are described using formats of data records shown in FIG. 2 and FIG. 3.

FIG. 2 shows a format of a data record 60R stored in the first database 60. As shown in FIG. 2, the data record 60R includes a member ID, receipt data and list data. The member ID specifies an electronic receipt member. The receipt data is data of a receipt showing contents of a transaction relating to commodities purchased in one retail store by the electronic receipt member identified by the member ID. The receipt data includes store data, transaction date and time, a transaction number, a terminal number, a name of person in charge, purchased commodity data, a total amount, payment data and the like.

The store data includes a store ID and a store name. The store name indicates a name of a store in which the transaction is performed. The transaction date and time indicates a date and time at which the transaction is established. The transaction number is a transaction identification number assigned by the POS terminal 21 that settles the transaction each time the transaction is established. The terminal number is a unique number assigned to the POS terminal 21 that settles the transaction. The name of person in charge indicates a name of a store clerk who signs in to the POS terminal 21 that settles the transaction. The purchased commodity data includes a commodity name, a sales amount and the like of a purchased commodity, i.e., a commodity purchased in the transaction. The total amount indicates a total amount of the purchased commodity. The payment data indicates payment data of the electronic receipt member for the total amount. For example, if the electronic receipt member performs payment with cash, the payment data includes a deposit amount and a change amount.

The list data includes items required to create a list of the receipt data. In the information terminal 30, under control of the electronic receipt server 10, an image in which the receipt data contained in the data record 60R including the member ID stored in the memory is listed can be displayed on the display device. However, it is not preferable to display a list of all data items of the receipt data from the viewpoint of a screen size of the display device of the information terminal 30. Any list may be used as long as the electronic receipt member can identify the receipt data. Therefore, the electronic receipt server 10 generates list data so that a list of a plurality of items selected from the items of the receipt data is displayed on the information terminal 30. The list data is composed of the selected items. The list data includes, for example, the store ID, the store name, the transaction date and time, the transaction identification number and the total amount. Alternatively, the list data may be composed of, for example, the store name, the transaction date and time and the total amount.

FIG. 3 shows a format of a data record 70R stored in the second database 70. As shown in FIG. 3, the data record 70R includes a management code, a password and receipt data. The management code is a unique code for specifying the receipt data. For example, the management code is a combination of the store ID, the transaction date and time and the transaction identification number included in the receipt data. Specifically, if the store ID is “999”, the date and time is “15:15 on Mar. 3, 2018” and the transaction identification number is “1234” in the receipt data, the management code is “9992018030315151234”. Alternatively, the management code may be “1234201803031515999”. The management code may include a date rather than the date and time. Specifically, the management code may be “999201803031234” or “123420180303999”. The management code is not limited thereto. The management code may be a series of numbers assigned each time the receipt data is generated. In short, the management code may be any code as long as it can specify one receipt data.

The password is a character string for certifying that a user of the management code is the person who receives a receipt generated according to the receipt data specified by the management code. The password is, for example, a combination of letters and numbers. The password does not necessarily have to correspond with the management code in a one to one manner. A common password may be set for different management codes.

Incidentally, the first database 60 and the second database 70 respectively store the data record 60R and the data record 70R, for example, for 13 months. The data records 60R and 70R after 13 months are deleted from the first database 60 and the second database 70. A retention period for the data record 60R and the data record 70R is not limited to 13 months. The retention periods for the data record 60R and the data record 70R may be different. For example, the retention period for the data record 70R may be shorter than that for the data record 60R.

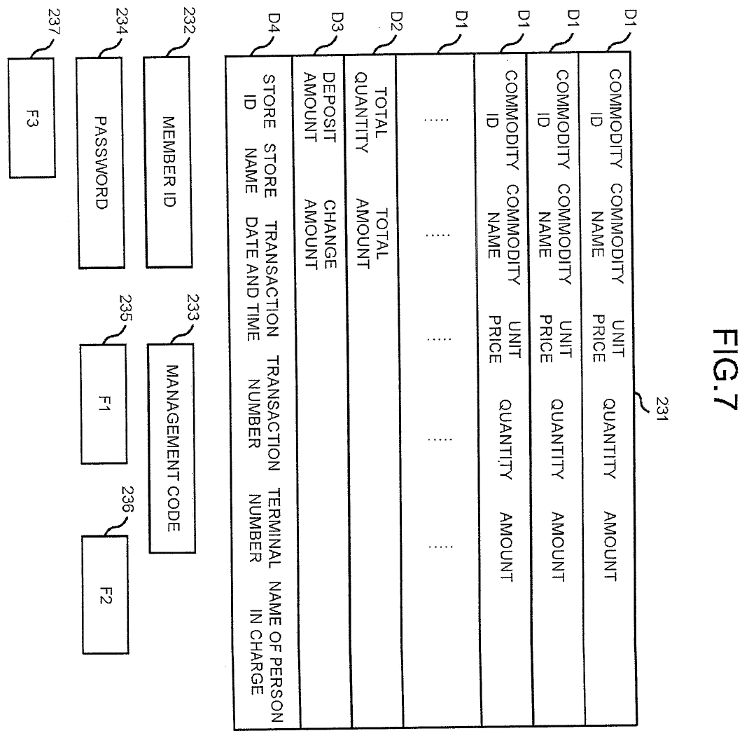

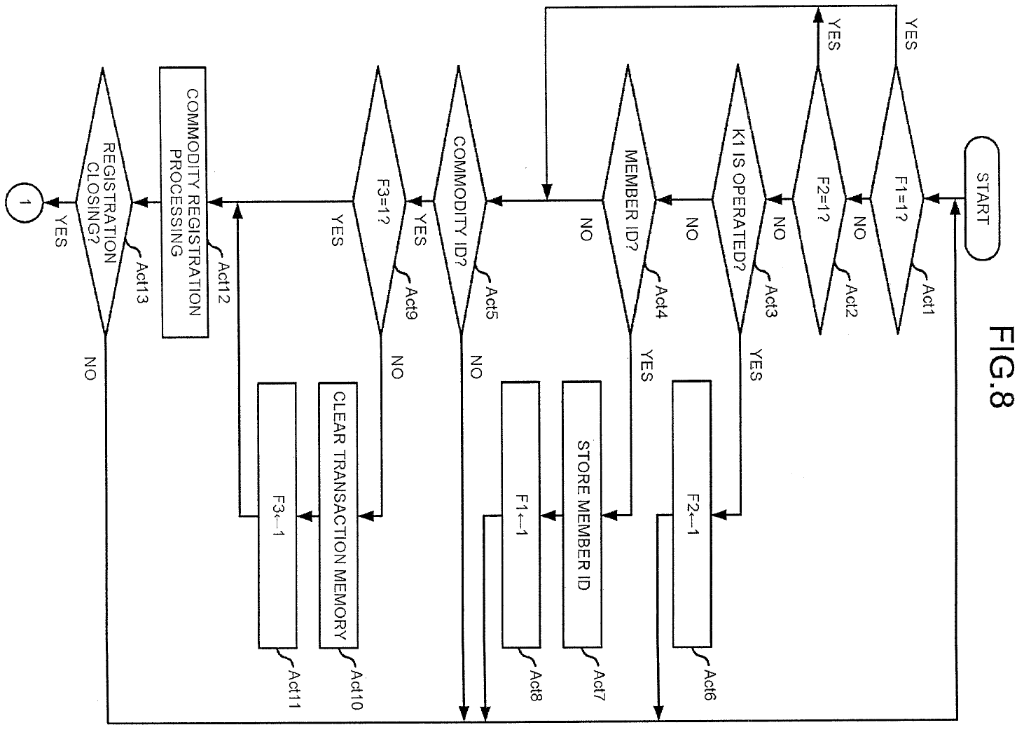

Next, configurations of main components of the electronic receipt server 10 and the POS terminal 21 are described with reference to block diagrams shown in FIG. 4 and FIG. 6 and memory maps shown in FIG. 5 and FIG. 7. FIG. 4 shows a circuit configuration of main components of the electronic receipt server 10. As shown in FIG. 4, the electronic receipt server 10 includes a processor 11, a main memory 12, an auxiliary storage device 13, a communication interface 14 and a system transmission line 15. The system transmission line 15 includes an address bus, a data bus, a control signal line and the like. The system transmission line 15 connects the processor 11 with the other components directly or indirectly through a signal input/output circuit, thereby transmitting and receiving data signals therebetween. The processor 11, the main memory 12 and the auxiliary storage device 13 are connected via the system transmission line 15 to constitute a computer of the electronic receipt server 10.

The processor 11 acts as a central component of the above computer. The processor 11 controls each section to perform various functions of the electronic receipt server 10 by executing an operating system or application programs. The processor 11 is, for example, a Central Processing Unit (CPU).

The main memory 12 acts as a main storage component of the above computer. The main memory 12 includes a non-volatile memory area and a volatile memory area. The main memory 12 stores the operating system or application programs in the non-volatile memory area. The main memory 12 may store data necessary for the processor 11 executing processing for controlling each section in the nonvolatile or volatile memory area. The main memory 12 uses the volatile memory area as a work area in which data is appropriately rewritten by the processor 11. The non-volatile memory area is, for example, a Read Only Memory (ROM). The volatile memory area is, for example, a Random Access Memory (RAM).

The auxiliary storage device 13 acts as an auxiliary storage component of the above computer. For example, the auxiliary storage device 13 may be an Electric Erasable Programmable Read-Only Memory (EEPROM), an Hard Disc Drive (HDD), a Solid State Drive (SSD) or the like. The auxiliary storage device 13 stores data to be used when the processor 11 performs various processing and data generated in processing performed by the processor 11. The auxiliary storage device 13 may store the application programs described above in some cases.

The communication interface 14 is connected to the network 50. The communication interface 14 establishes data communication in conformity with a preset communication protocol with another device via the network 50.

In the electronic receipt server 10 having such a configuration, a management table 121 having a data structure shown in FIG. 5 is formed in the volatile memory area of the main memory 12. The management table 121 has a management code field f1, a password field f2, a member ID field f3 and a status field f4. The status indicates a state of data stored in the same row. The state includes a state before the member ID is set and a state after the member ID is set. In the present embodiment, the status indicating the state before setting, i.e., when the member ID is “0” is set to “0”, and the status indicating the state after setting is set to “1”.

FIG. 6 shows a circuit configuration of main components of the POS terminal 21. As shown in FIG. 6, the POS terminal 21 includes a processor 211, a main memory 212, an auxiliary storage device 213, a clock 214, a communication interface 215, an automatic change machine 216, a keyboard 217, a display 218, a scanner 219, a printer 220, a card reader 221 and a system transmission line 222. The system transmission line 222 is an address bus, a data bus, a control signal line or the like. The system transmission line 222 connects the processor 211 with the other components directly or indirectly through a signal input/output circuit, thereby transmitting and receiving data signals therebetween. The processor 211, the main memory 212 and the auxiliary storage device 213 are connected via the system transmission line 222 to constitute a computer of the POS terminal 21.

The processor 211 acts as a central component of the above computer. The processor 211 controls each section to perform various functions of the POS terminal 21 by executing an operating system or application programs. The processor 211 is, for example, a CPU.

The main memory 212 acts as a main storage component of the above computer. The main memory 212 includes a non-volatile memory area and a volatile memory area. The main memory 212 stores the operating system or application programs in the non-volatile memory area. The main memory 212 may store data necessary for the processor 211 executing processing for controlling each section in the nonvolatile or volatile memory area. The main memory 212 uses the volatile memory area as a work area in which data is appropriately rewritten by the processor 211. The non-volatile memory area is, for example, a ROM. The volatile memory area is, for example, a RAM.

The auxiliary storage device 213 acts as an auxiliary storage component of the above computer. For example, the auxiliary storage device 213 may be an EEPROM, an HDD, an SSD or the like. The auxiliary storage device 213 stores data to be used when the processor 211 performs various processing and data generated in processing performed by the processor 211. The auxiliary storage device 213 may store the application programs described above in some cases.

The clock 214 counts the time. The processor 211 uses the time counted by the clock 214 as current time.

The communication interface 215 is connected to the network 24. The communication interface 215 establishes data communication in conformity with a preset communication protocol with another device connected via the network 24.

The automatic change machine 216 includes a coin unit and a bill unit. The coin unit sorts coins inserted into a coin insertion slot one by one and identifies a denomination thereof to store the coins by denomination in a safe. For example, the coin unit takes out a coin having the corresponding denomination from the safe based on change data to dispense the coin through a coin dispensing port. The bill unit sorts the bills inserted into a bill insertion slot one by one and identifies a denomination thereof to store the bills by denomination in a safe. For example, the bill unit takes out a bill having the corresponding denomination from the safe based on the change data to dispense the bill through a bill dispensing port.

The keyboard 217 is a dedicated input device provided with various function keys such as a multiplication key, a subtotal key, a closing key, and the like, in addition to numeric keys for inputting numerical values such as a quantity, an amount and the like. A function required by the POS terminal 21 may be assigned to any key in a general-purpose keyboard. The closing key is operated by an operator to instruct closing of registration in a transaction relating to the sales of the commodity or provision of a service. For example, a cash total key, a credit total key, etc. serve as the closing key.

The display 218 displays a commodity name, a sales amount, a total amount, a change amount, and the like. There are two types of displays 218: one for a store clerk who operates the POS terminal 21 and one for a customer. A touch panel that combines the functions of the input device and the display device may be used instead of the keyboard 217 and the display 218.

The scanner 219 scans a code symbol. The code symbol is, for example, a barcode. The code symbol may be, for example, a two-dimensional data code. The scanner may be a scanner that scans a code symbol through scanning using laser light, or may be a scanner that reads a code symbol from an image captured by an image-capturing device.

A code symbol obtained by encoding a commodity ID for identifying the commodity is attached to each commodity sold in the retail store. As described above, a code symbol obtained by encoding the member ID is displayed on the information terminal 30 possessed by the electronic receipt member. The scanner 219 can read these code symbols.

The printer 220 prints receipt data indicating details of the transaction on a receipt paper. The receipt paper on which the receipt data is printed is discharged from a receipt issuing port, cut by a cutter, and then issued as a paper receipt.

The card reader 221 reads card data recorded on a card medium such as a credit card or a point card.

The POS terminal 21 having such a configuration uses one of the functional keys arranged in the keyboard 217 as a post-issuance key K1. The post-issuance key K1 is operated to instruct that the electronic receipt is to be received later. For example, the post-issuance key K1 is operated at the time of the transaction performed by an electronic receipt member who forgets the information terminal 30 and cannot present the member ID to a store clerk in the retail store. Alternatively, the post-issuance key K1 may be operated at the time of the transaction performed by a customer who is scheduled to become an electronic receipt member later and intends to receive an electronic receipt as a receipt of the current transaction. The post-issuance key K1 is operated by a so-called cashier, i.e., a store clerk who operates the POS terminal 21. For example, the post-issuance key K1 may be operated by a customer by providing a touch key having the same function as the post-issuance key K1 on a touch panel serving as the display for displaying information to the customer.

In the POS terminal 21, a transaction memory 231, a member ID memory 232, a management code memory 233, a password memory 234, a first flag memory 235, a second flag memory 236 and a third flag memory 237 are formed in the volatile memory area of the main memory 212, as shown in FIG. 7.

The transaction memory 231 stores commodity sales data D1, total data D2, payment data D3 and transaction identification data D4 as data relating to one transaction, respectively. The commodity sales data D1 includes a commodity ID, a commodity name, a unit price, a sales quantity and a sales amount. The total data D2 includes a total quantity and a total amount. The payment data D3 includes a deposit amount and a change amount. The transaction identification data D4 includes a store ID, a store name, a transaction date and time, a transaction number, a terminal number and a name of person in charge.

The member ID memory 232 stores a member ID of the electronic receipt member. The management code memory 233 stores the management code described above. The password memory 234 stores the password described above.

The first flag memory 235 stores an electronic receipt flag F1. The electronic receipt flag F1 is 1-bit data for identifying whether or not the transaction is a transaction in which the reception of an electronic receipt as the receipt is instructed. In the present embodiment, the electronic receipt flag F1 is “1” in the case of a transaction in which the reception of the electronic receipt as the receipt is instructed, and is “0” in the case of a transaction in which the reception of the electronic receipt as the receipt is not instructed.

The second flag memory 236 stores a post-issuance flag F2. The post-issuance flag F2 is 1-bit data for identifying whether or not the transaction is a transaction in which an instruction to receive an electronic receipt later is made. In the present embodiment, the post-issuance flag F2 is “1” in the case of a transaction in which the instruction to receive the electronic receipt later is made, and is “0” in the case of a transaction in which the instruction to receive the electronic receipt later is not made.

The third flag memory 237 stores a transaction in-execution flag F3. The transaction in-execution flag F3 is 1-bit data for identifying whether or not a transaction is being executed. In the present embodiment, the transaction in-execution flag F3 is “1” at the time the transaction is being executed, and is “0” at the time no transaction is being executed.

The POS terminal 21 having such a hardware configuration may be an existing POS terminal without any change. Alternatively, the POS terminal 21 may be a self-service type POS terminal in which the customer performs all operations from registration to settlement of a purchased commodity.

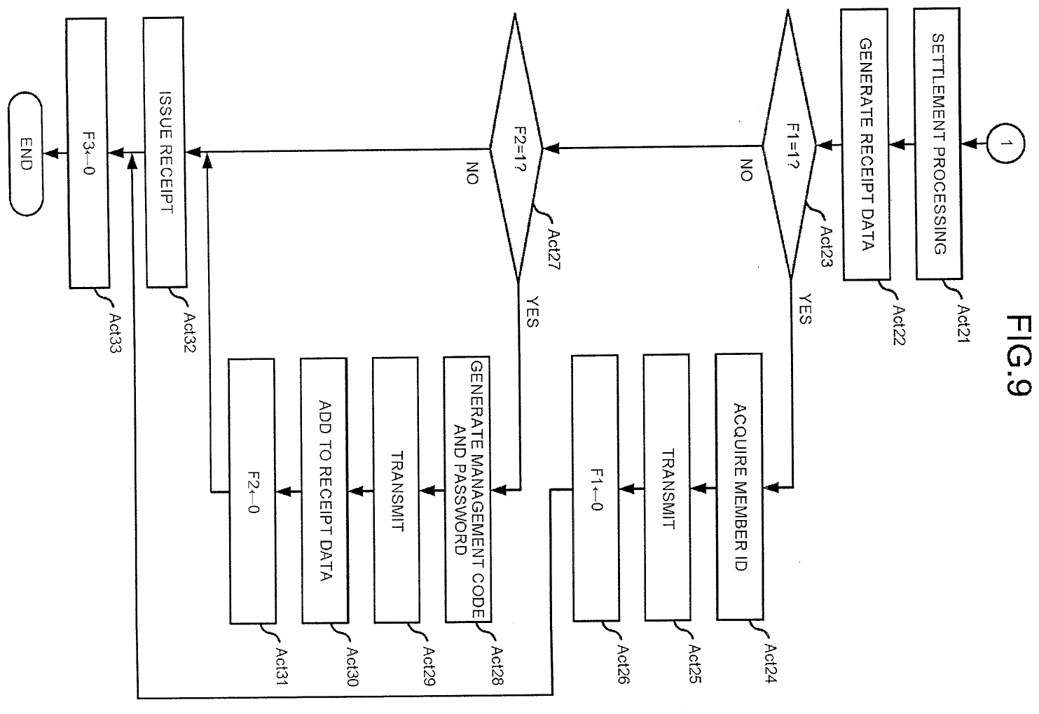

Next, main operations performed by the electronic receipt system 100 (mainly by the POS terminal 21 and the electronic receipt server 10) are described using the flowcharts shown in FIG. 8 to FIG. 12.

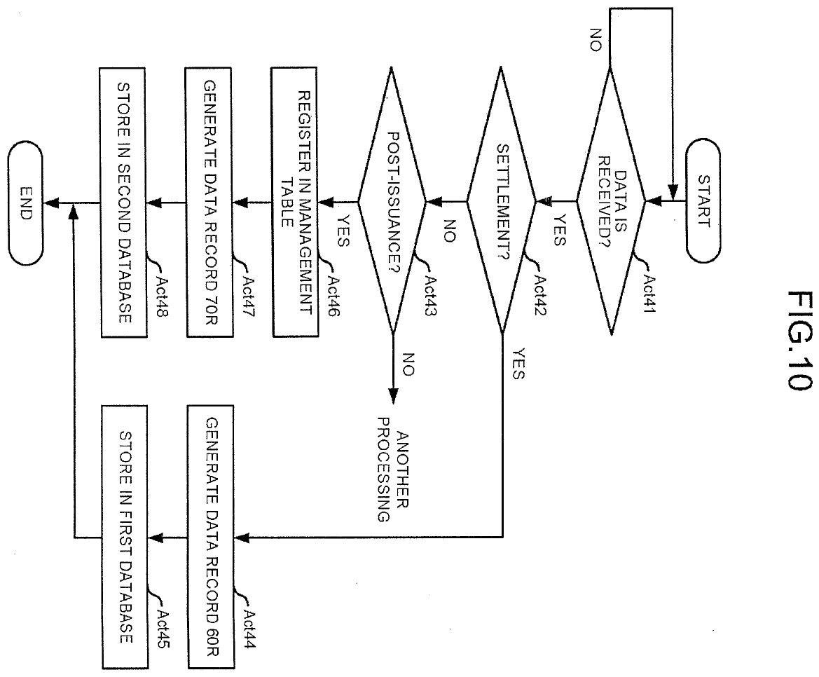

The processor 211 of the POS terminal 21 executes data processing relating to one transaction according to procedures shown in the flowcharts in FIG. 8 and FIG. 9. The data processing is performed according to a processing program stored in the main memory 212 or the auxiliary storage device 213. The contents of the processing shown in FIG. 8 and FIG. 9 and described below are merely an example. The processing procedure and the processing contents are not particularly limited as long as the same results can be achieved.

The processor 211 checks the electronic receipt flag F1 in the first flag memory 235 in Act 1 in FIG. 8. Initially, the electronic receipt flag F1 is reset to “0”. If it is determined that the electronic receipt flag F1 is reset to “0”, the processor 211 takes No in Act 1, and then proceeds to the processing in Act 2. The processor 211 checks the post-issuance flag F2 in the second flag memory 236 in Act 2. Initially, the post-issuance flag F2 is reset to “0”. If it is determined that the post-issuance flag F2 is reset to “0”, the processor 211 takes No in Act 2, and then proceeds to the processing in Act 3.

The processor 211 determines whether or not the post-issuance key K1 is operated in Act 3. If the post-issuance key K1 is not operated, the processor 211 takes No in Act 3, and then proceeds to the processing in Act 4. The processor 211 determines whether or not the member ID is input in Act 4. If no member ID is input, the processor 211 takes No in Act 4, and then proceeds to the processing in Act 5. The processor 211 determines whether or not a commodity ID of the purchased commodity is input in Act 5. If no commodity ID is input, the processor 211 takes No in Act 5, and then returns to the processing in Act 1. Thus, the processor 211 stands by until the post-issuance key K1 is operated in Act 3, the member ID is input in Act 4 or the commodity ID is input in Act 5 in a state in which both the electronic receipt flag F1 and the post-issuance flag F2 are reset to “0”.

In the standby state in Act 3 to Act 5, if the processor 211 detects that the post-issuance key K1 is operated, the processor 211 takes Yes in Act 3, and then proceeds to the processing in Act 6. The processor 211 sets the post-issuance flag F2 in the second flag memory 236 to “1” in Act 6. Thereafter, the processor 211 returns to the processing in Act 1. The processor 211 takes No in Act 1, and then proceeds to the processing in Act 2. Since the post-issuance flag F2 is set to “1” this time, the processor 211 takes Yes in Act 2, and then proceeds to the processing in Act 5. In other words, after the post-issuance key K1 is operated and the post-issuance flag F2 is set to “1”, the processor 211 continues to stand by until the commodity ID is input.

On the other hand, if a code symbol indicating the member ID displayed on the information terminal 30 possessed by the electronic receipt member is scanned by the scanner 219 in the standby state in Act 3 to Act 5, the processor 211 determines that the member ID is input. Alternatively, in a case in which a card number of a credit card or a point card possessed by the electronic receipt member is associated with the member ID of the electronic receipt member, if the card number associated with the member ID is read by the card reader 221, the processor 211 may determine that the member ID is input.

If the member ID is input, the processor 211 takes Yes in Act 4, and then proceeds to the processing in Act 7. The processor 211 writes the input member ID in the member ID memory 232 to store the input member ID in Act 7. The processor 211 sets the electronic receipt flag F1 in the first flag memory 235 to “1” in Act 8. Thereafter, the processor 211 returns to the processing in Act 1. In this case, since the electronic receipt flag F1 is set to “1”, the processor 211 takes Yes in Act 1, and then proceeds to the processing in Act 5. In other words, after the member ID is input and the electronic receipt flag F1 is set to “1”, the processor 211 continues to stand by until the commodity ID is input.

If a code symbol indicating the commodity ID attached to the purchased commodity is scanned by the scanner 219, the processor 211 determines that the commodity ID is input. Alternatively, if a code corresponding to the commodity ID is input by a key operation through the keyboard 217, the processor 211 may determine that the commodity ID is input.

If the commodity ID is input, the processor 211 takes Yes in Act 5, and then proceeds to the processing in Act 9. The processor 211 checks the transaction in-execution flag F3 in the third flag memory 237 in Act 9. Initially, the transaction in-execution flag F3 is reset to “0”. If it is determined that the transaction in-execution flag F3 is reset to “0”, the processor 211 takes No in Act 9, and then proceeds to the processing in Act 10. The processor 211 clears the transaction memory 231 in Act 10. The processor 211 sets the transaction in-execution flag F3 in the third flag memory 237 to “1” in Act 11. Thereafter, the processor 211 proceeds to the processing in Act 12.

The processor 211 executes commodity registration processing in Act 12. Specifically, the processor 211 acquires a commodity record specified based on the input commodity ID. The commodity record is acquired from a commodity database by inquiring the POS server 22 based on the commodity ID. If a local file of the commodity database is downloaded to each POS terminal 21, the commodity record may be acquired from the local file. The processor 211 multiplies the sales quantity by the unit price included in the commodity record to calculate a sales amount. The sales quantity is usually “1”. When a multiplier is input through the numeric keys and a multiplication key on the keyboard 217, the multiplier is the sales quantity. The processor 211 generates the commodity sales data D1 from the commodity name and the unit price included in the commodity record and the sales quantity and the sales amount described above. The processor 211 writes the commodity sales data D1 in the transaction memory 231 to store the commodity sales data D1. The commodity sales data D1 is sequentially stored in the transaction memory 231. The processor 211 calculates a total quantity and a total amount by respectively totaling the quantity and the amount in the commodity sales data D1 stored in the transaction memory 231. Then, the processor 211 writes the total data D2 including the total quantity and the total amount in the transaction memory 231 to store the total data D2. Only the latest data is stored as the total data in the transaction memory 231. The processor 211 controls the display 218 to display the commodity name, the unit price, the sales quantity and the sales amount in the commodity sales data stored in the transaction memory 231, the total quantity and the total amount. Such commodity registration processing may be a known processing performed by an existing POS terminal without any change.

After the commodity registration processing is terminated, the processor 211 determines whether or not registration closing is input in Act 13. If the registration closing is not input, the processor 211 takes No in Act 13, and then returns to the processing in Act 1.

At this time, if both the electronic receipt flag F1 and the post-issuance flag F2 are reset to “0”, the processor 211 stands by until the post-issuance key K1 is operated, the member ID is input or the commodity ID is input. If the electronic receipt flag F1 or the post-issuance flag F2 is set to “1”, the processor 211 stands by until the commodity ID is input. In the standby state, if a commodity ID of second or subsequent commodity is input, since the transaction in-execution flag F3 is already set to “1” at this time point, the processor 211 takes Yes in Act 9, and then proceeds to the processing in Act 12. In other words, the processor 211 skips the processing in Act 10 and Act 11 to execute the above-described commodity registration processing.

If the closing key on the keyboard 217 is operated, the processor 211 determines that the registration closing is input. If the registration closing is input, the processor 211 takes Yes in Act 13, and then proceeds to the processing in Act 21 in FIG. 9. The processor 211 executes settlement processing in Act 21.

The settlement processing may be a known processing performed by an existing POS terminal without any change. For example, the processor 211 calculates a change amount based on a deposit amount inserted into the automatic change machine 216. Then, the processor 211 displays the change amount on the display 218, and discharges cash corresponding to the change amount from the automatic change machine 216. The processor 211 writes the payment data D3 including the deposit amount and the change amount, and the transaction identification data D4 including the store ID, the store name, he transaction date and time, the transaction number, the terminal number and the name of person in charge in the transaction memory 231 to store them. In the transaction identification data D4, the store ID, the store name and the terminal number are stored in advance in the main memory 212 or the auxiliary storage device 213 of the POS terminal 21. The transaction date and time is a date and time read from the clock 214. The name of person in charge is a name of a person in charge who signs in to the POS terminal 21, and is stored in the main memory 212. The terminal number is a value of a counter that counts up the value each time the settlement processing is performed.

The settlement processing is not limited to a settlement processing for payment with cash. The settlement processing may be, for example, a settlement processing for payment with credit card or a settlement processing for payment with electronic money.

If the settlement processing is terminated, the processor 211 proceeds to the processing in Act 22. The processor 211 generates a so-called receipt data indicating contents of the transaction based on the commodity sales data D1, the total data D2, the payment data D3 and the transaction identification data D4 stored in the transaction memory 231 in Act 22.

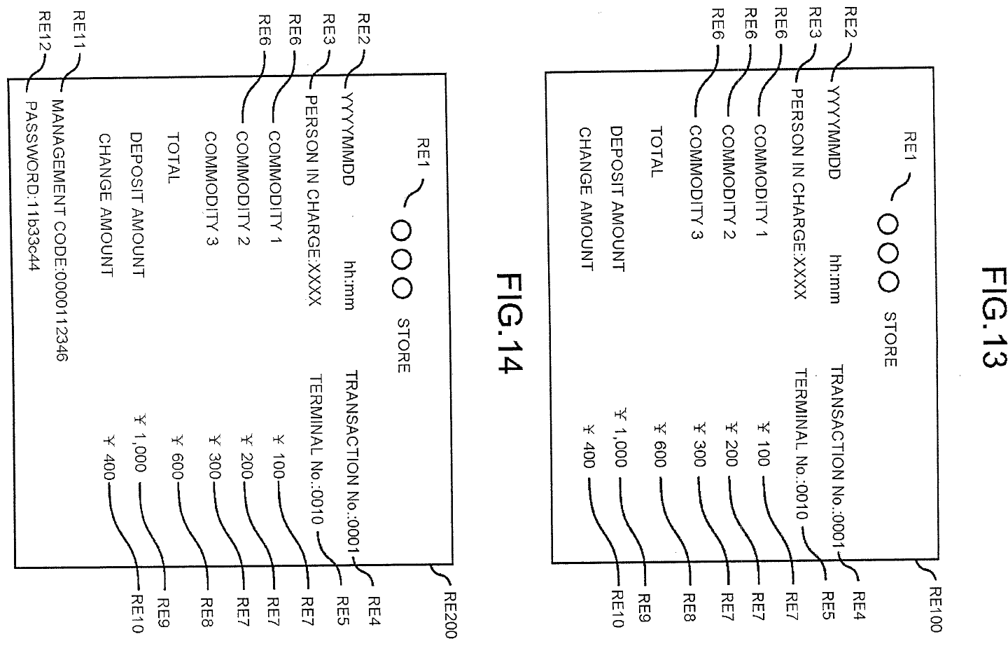

FIG. 13 is a diagram illustrating a receipt RE100. On the receipt RE100, a store name RE1, a transaction date and time RE2, a name of person in charge RE3, a transaction number RE4, a terminal number RE5, a commodity name RE6 and a sales amount RE7 of a purchased commodity, a total amount RE8, a deposit amount RE9, a change amount RE10, etc. are recorded. In this case, the receipt data is generated using the commodity name and the sales amount included in the commodity sales data D1, the total amount included in the total data D2, the deposit amount and the change amount included in the payment data D3, and the store name, the transaction date and time, the transaction number, the terminal number and the name of person in charge included in the transaction identification data D4.

After the receipt data is generated, the processor 211 proceeds to the processing in Act 23. The processor 211 checks the electronic receipt flag F1 in Act 23. If the electronic receipt flag F1 is reset to “0”, the processor 211 proceeds to the processing in Act 27. The processor 211 checks the post-issuance flag F2 in Act 27. If the post-issuance flag F2 is reset to “0”, the processor 211 takes No in Act 27, and then proceeds to the processing in Act 32. The processor 211 outputs the receipt data to the printer 220 to control printing of the receipt in Act 32. Under this control, the printer 220 prints the receipt RE100 having a layout shown in FIG. 13 on a receipt paper and issues the printed receipt RE100, for example.

After the printing control of the receipt RE100 is performed, the processor 211 proceeds to the processing in Act 33. The processor 211 resets the transaction in-execution flag F3 to “0” in Act 33. As described above, the processor 211 terminates the transaction in which the electronic receipt flag F1 and the post-issuance flag F2 are both “0”, i.e., the transaction performed by a customer who only receives a paper receipt as the receipt.

If the electronic receipt flag F1 is set to “1”, i.e., if the closing of the transaction in which the instruction to receive the electronic receipt as the receipt is made is instructed, the processor 211 takes Yes in Act 23, and then proceeds to the processing in Act 24. The processor 211 acquires the member ID from the member ID memory 232 in Act 24. Then, the processor 211 controls the communication interface 215 to transmit the member ID and the receipt data generated in Act 22 to the electronic receipt server 10 in Act 25. Under this control, the communication interface 215 transmits data including the member ID and the receipt data to the electronic receipt server 10. Hereinafter, the data including the member ID and the receipt data is referred to as electronic receipt settlement data. The electronic receipt settlement data is transmitted to the network 50 via the router 23 of the POS system 20 and is received by the communication interface 14 of the electronic receipt server 10.

After the electronic receipt settlement data is transmitted, the processor 211 proceeds to the processing in Act 26. The processor 211 resets the electronic receipt flag F1 to “0” in Act 26. Thereafter, the processor 211 proceeds to the processing in Act 33. The processor 211 resets the transaction in-execution flag F3 to “0” in Act 33. As described above, the processor 211 terminates the transaction in which the electronic receipt flag F1 is “1”, i.e., the transaction performed by the customer who receives the electronic receipt as the receipt.

If the post-issuance flag F2 is set to “1”, i.e., if closing of the transaction in which the instruction to receive the electronic receipt later is made is instructed, the processor 211 determines Yes in Act 27, and then proceeds to the processing in Act 28. The processor 211 generates the management code and the password in Act 28. As described above, the processor 211 generates a unique management code from the receipt data generated in Act 22. The processor 211 generates a password using random numbers generated from a random number generator (not shown) and an alphabet.

After the management code and the password are generated, the processor 211 proceeds to the processing in Act 29. The processor 211 controls the communication interface 215 to transmit the management code and the password, and the receipt data generated in Act 22 to the electronic receipt server 10 in Act 29. Under this control, the communication interface 215 transmits data including the management code, the password and the receipt data to the electronic receipt server 10. Hereinafter, the data including the management code, the password, and the receipt data is referred to as electronic receipt post-issuance data. The electronic receipt post-issuance data is transmitted to the network 50 through the router 23 of the POS system 20, and is received by the communication interface 14 of the electronic receipt server 10.

After the electronic receipt post-issuance data is transmitted, the processor 211 proceeds to the processing in Act 30. The processor 211 adds the management code and the password to the receipt data in Act 30. The processor 211 resets the post-issuance flag F2 to “0” in Act 31. Thereafter, the processor 211 proceeds to the processing in Act 32. Specifically, the processor 211 outputs the receipt data to the printer 220 to control printing of the receipt in Act 32. Under this control, the printer 220 prints a receipt RE200 having a layout shown in FIG. 14 on a receipt paper and issues the printed receipt RE200, for example.

FIG. 14 shows the receipt RE200. On the receipt RE200, a management code RE11 and a password RE12 are recorded in addition to the store name RE1, the transaction date and time RE2, the name of person in charge RE3, the transaction number RE4, the terminal number RE5, the commodity name RE6 and the sales amount RE7 of the purchased commodity, the total amount RE8, the deposit amount RE9 and the change amount RE10, which are the same as those of the receipt RE100.

After the printing control of the receipt RE200 is performed, the processor 211 proceeds to the processing in Act 33. The processor 211 resets the transaction in-execution flag F3 to “0” in Act 33. As described above, the processor 211 terminates the transaction in which the post-issuance flag F2 is “1”, i.e., the transaction performed by the customer who instructs to receive the electronic receipt later.

As described above, in the POS terminal 21 according to the present embodiment, the receipt RE200 on which the management code and the password are printed for the transaction performed by the customer who instructs to receive the electronic receipt later is issued. The receipt data to which the management code and the password are added is transmitted from the POS terminal 21 to the electronic receipt server 10.

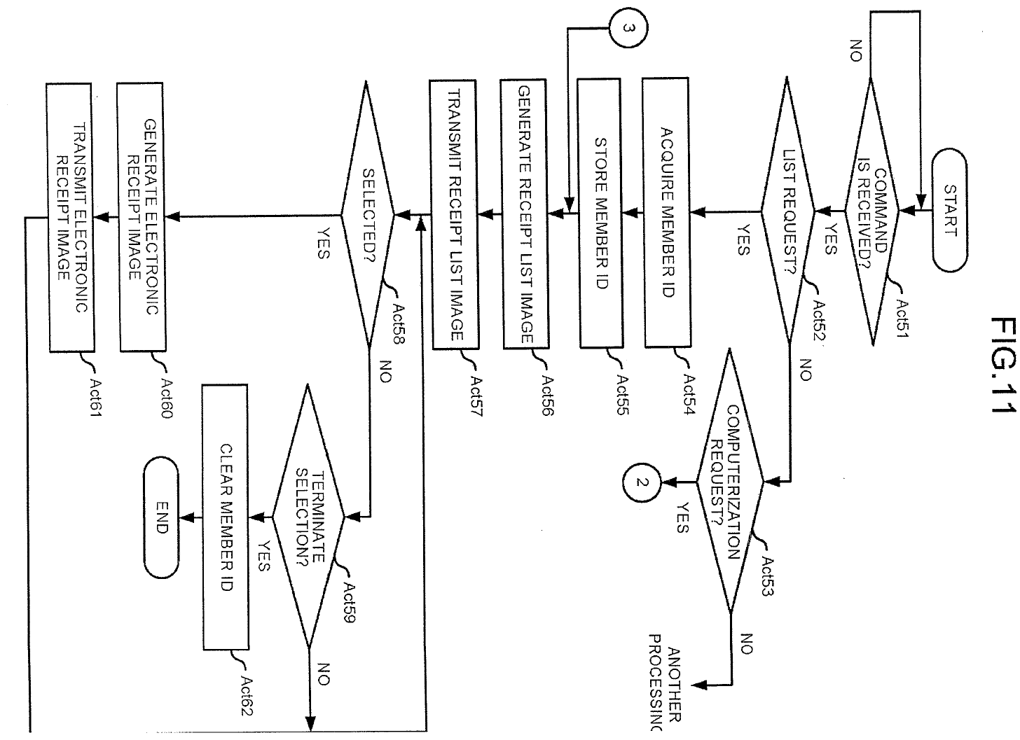

The processor 11 of the electronic receipt server 10 executes processing having procedures shown in flowcharts in FIG. 10 to FIG. 12. The contents of the processing shown in FIG. 10 to FIG. 12 and described below are merely an example. The processing procedure and the processing contents are not particularly limited as long as the same results can be achieved.

The processor 11 stands by until the data from the POS system 20 is received in Act 41 in FIG. 10. Then, if the data from the POS system 20 is received via the communication interface 14, the processor 11 takes Yes in Act 41, and then proceeds to the processing in Act 42. The processor 11 determines whether or not the received data is the electronic receipt settlement data in Act 42. Then, if the received data is not the electronic receipt settlement data, the processor 11 takes No in Act 42, and then proceeds to the processing in Act 43. The processor 11 determines whether or not the received data is the electronic receipt post-issuance data in Act 43. Then, if the received data is not the electronic receipt post-issuance data, the processor 11 takes No in Act 43, and then executes another processing. Another processing is processing performed based on the received data.

If the received data is the electronic receipt settlement data, the processor 11 takes Yes in Act 42, and then proceeds to the processing in Act 44. The processor 11 creates the data record 60R based on the electronic receipt settlement data in Act 44. Specifically, the processor 11 generates list data from the receipt data included in the electronic receipt settlement data. Then, the processor 11 adds the list data to the member ID and the receipt data included in the electronic receipt settlement data to create the data record 60R. After the data record 60R is created, the processor 11 proceeds to the processing in Act 45. The processor 11 stores the created data record 60R in the first database 60 in Act 45. Thus, the processor 11 terminates the processing at the time the received data is the electronic receipt settlement data.

If the received data is the electronic receipt post-issuance data, the processor 11 takes Yes in Act 43, and then proceeds to the processing in Act 46. The processor 11 registers the management code and the password included in the electronic receipt post-issuance data respectively in the field f1 and the field f2 in the management table 121 in Act 46. The processor 11 sets the member ID in the field f3 in the management table 121 to “0” and sets the status in the field f4 to “0”.

Thus, after the management code, the password, the member ID and the status are registered in the management table 121, the processor 11 proceeds to the processing in Act 47. The processor 11 creates the data record 70R based on the electronic receipt post-issuance data in Act 47. Specifically, the processor 11 creates the data record 70R from the management code and the password included in the electronic receipt post-issuance data and the receipt data. After the data record 70R is created, the processor 11 proceeds to the processing in Act 48. The processor 11 stores the data record 70R in the second database 70 in Act 48. Thus, the processor 11 terminates the processing at the time the received data is the electronic receipt post-issuance data.

The processor 11 stands by until a command is received in Act 51 in FIG. 11. Then, if the command is received via the communication interface 14, the processor 11 takes Yes in Act 51, and then proceeds to the processing in Act 52. The processor 11 determines whether or not the received command is a list request command in Act 52. Then, if the received command is not the list request command, the processor 11 takes No in Act 52, and then proceeds to the processing in Act 53. The processor 11 determines whether or not the received command is a computerization request command in Act 53. Then, if the received command is not the computerization request command, the processor 11 takes No in Act 53, and then executes another processing. Another processing is processing performed based on the received command.

The list request command is transmitted from the information terminal 30 possessed by the electronic receipt member. If software “electronic receipt application” is started and a receipt menu is selected from a menu screen, the information terminal 30 transmits the list request command to the electronic receipt server 10. The list request command includes the member ID stored in a memory of the information terminal 30.

If it is determined that the command received via the communication interface 14 is the list request command, the processor 11 takes Yes in Act 52, and then proceeds to the processing in Act 54. The processor 11 acquires the member ID from the list request command in Act 54. Then, the processor 11 stores the member ID in the member ID memory 232 in Act 55.

Thus, after the member ID included in the list request command is stored in the member ID memory 232, the processor 11 proceeds to the processing in Act 56. The processor 11 generates a receipt list image in Act 56. Specifically, the processor 11 extracts the data record 60R including the member code stored in the member ID memory 232 from the first database 60, and generates the receipt list image according to the list data in the data record 60R.

After the receipt list image is generated, the processor 11 proceeds to the processing in Act 57. The processor 11 controls the communication interface 14 to transmit the data of the generated receipt list image to the information terminal 30 that transmits the list request command in Act 57. Under this control, the communication interface 14 transmits the data of the receipt list image to the information terminal 30 that transmits the list request command. The data of the receipt list image transmitted from the communication interface 14 is transmitted to the information terminal 30 via the network 50 and the base station 40. In this way, the receipt list image is displayed on a display device of the information terminal 30 that transmits the list request command. The electronic receipt member who uses the information terminal 30 operates an input device to select data desired to be viewed on the electronic receipt from the receipt list image. Alternatively, the electronic receipt member instructs to terminate the selection.

The processor 11 that controls the transmission of the receipt list image determines whether or not the data desired to be viewed on the electronic receipt is selected in the information terminal 30 in Act 58. If the data desired to be viewed on the electronic receipt is not selected, the processor 11 takes No in Act 58, and then proceeds to the processing in Act 59. The processor 11 determines whether or not the instruction to terminate the selection is made in Act 59. If the instruction to terminate the selection is not made, the processor 11 takes No in Act 59, and then returns to the processing in Act 58. Here, the processor 11 stands by until the data desired to be viewed on the electronic receipt is selected in Act 58 or the instruction to terminate the selection is made in Act 59.

If the processor 11 detects that the data desired to be viewed on the electronic receipt is selected in the standby state in Act 58 and Act 59, the processor 11 takes Yes in Act 58, and then proceeds to the processing in Act 60. The processor 11 generates image data of the electronic receipt based on the receipt data in the data record 60R specified by the selected data in Act 60. Then, the processor 11 controls the communication interface 14 to transmit the image data of the electronic receipt to the information terminal 30 in Act 61. Under this control, the communication interface 14 transmits the image data of the electronic receipt to the information terminal 30 that transmits the list request command. The image data of the electronic receipt transmitted from the communication interface 14 is transmitted to the information terminal 30 via the network 50 and the base station 40. Thus, an image of the electronic receipt is displayed on the display device of the information terminal 30.

The processor 11 that controls the transmission of the image data of the electronic receipt returns to the standby state in Act 58 and Act 59. In the standby state, if the processor 11 detects that the instruction to terminate the selection is made, the processor 11 takes Yes in Act 59, and then proceeds to the processing in Act 62. The processor 11 clears the member ID stored in the member ID memory 232 in Act 62. Thus, the processor 11 terminates the processing at the time the list request command is received.

The computerization request command is transmitted from the information terminal 30 possessed by the electronic receipt member. If the software “electronic receipt application” is started and a receipt computerization menu is selected from the menu screen, the information terminal 30 transmits the computerization request command to the electronic receipt server 10. The computerization request command includes the member ID stored in the memory of the information terminal 30.

The receipt computerization menu enables reception of the electronic receipt later for a transaction in which the electronic receipt is not received as the receipt in the past. In a transaction performed a customer who instructs to receive the receipt later, the receipt RE200 on which the management code RE11 and the password RE12 are recorded as shown in FIG. 14 is issued. The electronic receipt member who receives the receipt RE200 can receive the receipt RE200 in the form of the electronic receipt later by starting the receipt computerization menu.

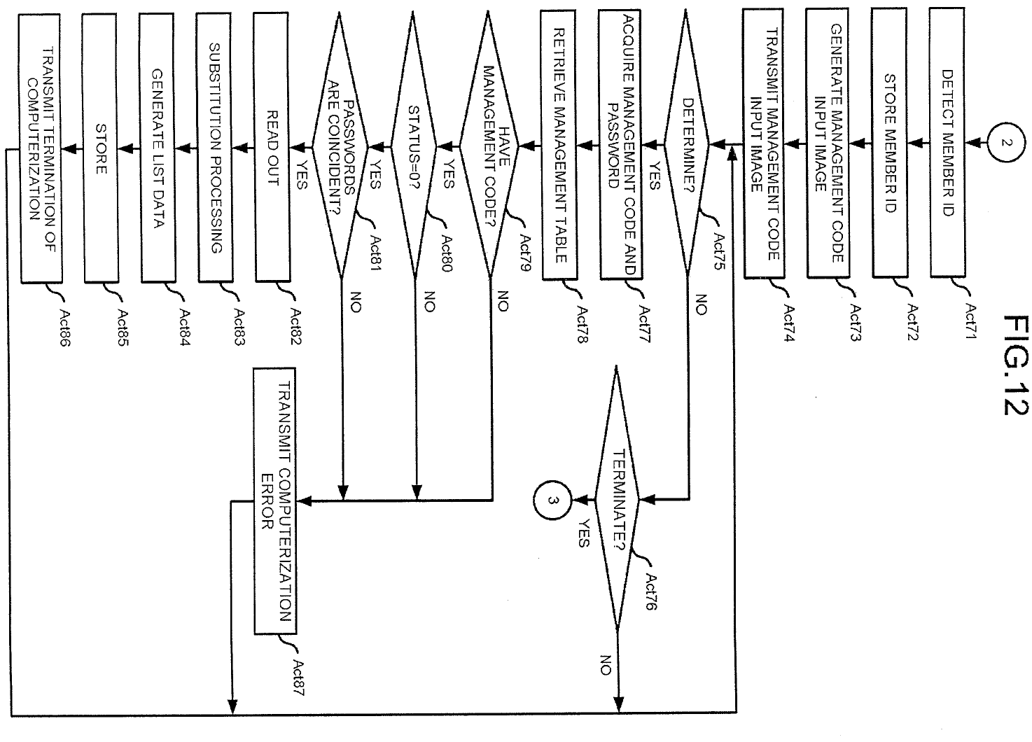

If it is determined that the command received via the communication interface 14 is the computerization request command, the processor 11 takes Yes in Act 53, and then proceeds to the processing in Act 71 in FIG. 12. The processor 11 extracts the member ID from the computerization request command in Act 71. Then, the processor 11 stores the member ID in the member ID memory 232 in Act 72.

After the member ID included in the computerization request command is stored in the member ID memory 232, the processor 11 proceeds to the processing in Act 73. The processor 11 generates a management code input image in Act 73. Then, the processor 11 controls the communication interface 14 to transmit data of the management code input image to the information terminal 30 that transmits the computerization request command in Act 74. Under this control, the communication interface 14 transmits the data of the management code input image to the information terminal 30 that transmits the computerization request command. The data of the management code input image transmitted from the communication interface 14 is transmitted to the information terminal 30 via the network 50 and the base station 40. Thus, the management code input image is displayed on the display device of the information terminal 30 that transmits the computerization request command.

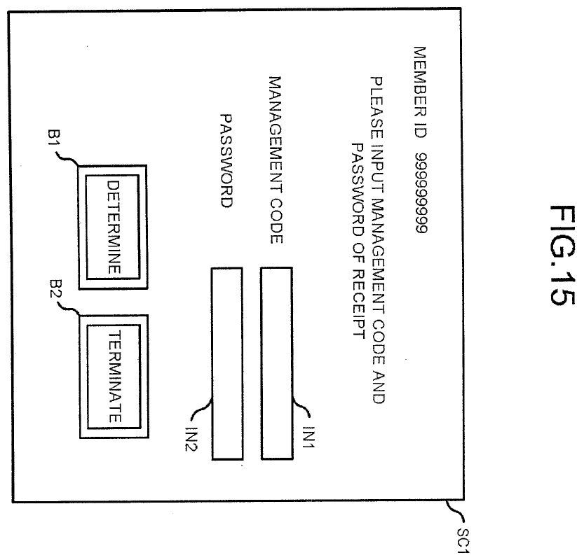

FIG. 15 shows a management code input image SC1. As shown in FIG. 15, the management code input image SC1 displays an input box IN1 for the management code, an input box IN2 for the password, and button images of a determination button B1 and a termination button B2.

The electronic receipt member who confirms the management code input image SC1 operates the input device of the information terminal 30 to input the management code and the password recorded in the receipt RE200 to the input box IN1 and the input box IN2, respectively. Then, the electronic receipt member touches the determination button B 1. Alternatively, the electronic receipt member may touch the termination button B2 without inputting data to the input box IN1 and the input box IN2.

The processor 11 that controls the transmission of the management code input image SC1 determines whether or not the determination button B1 is touched on the information terminal 30 in Act 75. If the determination button B1 is not touched, the processor 11 takes No in Act 75, and then proceeds to the processing in Act 76. The processor 11 determines whether or not the termination button B2 is touched in Act 76. If the termination button B2 is not touched, the processor 11 takes No in Act 76, and then returns to the processing in Act 75. Here, the processor 11 stands by until the determination button B1 is touched in Act 75 or the termination button B2 is touched in Act 76.

If the processor 11 detects that the determination button B1 is touched in the standby state in Act 75 and Act 76, the processor 11 acquires the management code and the password input to the input box IN1 and the input box IN2 in the management code input image SC1 from the information terminal 30 in Act 77. Then, the processor 11 retrieves the management table 121 with the management code and the password in Act 78.

The processor 11 determines whether or not the management code input to the input box IN1 is registered in the field f1 of the management table 121 in Act 79. If the management code is registered, the processor 11 takes Yes in Act 79, and then proceeds to the processing in Act 80. The processor 11 checks a status registered in the field f4 in a row in which the management code is registered in Act 80. Here, if the status is “0”, the processor 11 takes Yes in Act 80, and then proceeds to the processing in Act 81. The processor 11 determines whether or not the password registered in the field f2 in the row in which the management code is registered is coincident with the password input to the input box IN2 in Act 81. If the passwords are coincident, the processor 11 takes Yes in Act 81, and then proceeds to the processing in Act 82.

The processor 11 retrieves the second database 70 to read out the data record 70R including the same management code and password in Act 82. Then, the processor 11 executes a substitution processing in Act 83. The substitution processing includes a processing of substituting the member ID stored in the member ID memory 232 for the management code and the password in the data record 70R. The substitution processing includes a processing of substituting the member ID stored in the member ID memory 232 for “0” for the member ID registered in the field f3 in the same row as the field f1 and the field f2 in which the management code and the password are registered in the management table 121, and a processing of changing the status registered in the field f4 in the same row from “0” to “1”.

After the substitution processing, the processor 11 proceeds to the processing in Act 84. The processor 11 generates the list data described above from the receipt data of the data record 70R in which the member ID is substituted for the management code and the password in Act 84. Then, the processor 11 stores the data record 60R including the member ID, the receipt data and the list data in the first database 60 in Act 85.

Thus, after the data record 60R generated based on the data record 70R stored in the second database 70 is stored in the first database 60, the processor 11 proceeds to the processing in Act 86. The processor 11 controls the communication interface 14 to transmit a response command indicating termination of computerization to the information terminal 30 that transmits the computerization request command in Act 86. Under this control, the communication interface 14 transmits the response command indicating termination of computerization to the information terminal 30 that transmits the computerization request command. The response command indicating termination of computerization transmitted from the communication interface 14 is transmitted to the information terminal 30 via the network 50 and the base station 40. Thus, an image indicating that the computerization request is accepted is displayed on the display device of the information terminal 30 that transmits the computerization request command.

The processor 11 that controls the transmission of the response command then returns to the standby state in Act 75 and Act 76.

On the other hand, if the management code is not registered as a result of retrieving the management table 121 in Act 78, the management code input to the management code input image SC1 is incorrect. In this case, the processor 11 takes No in Act 79, and then proceeds to the processing in Act 87. Similarly, if the status is “1”, the data record 70R including the management code managed in the management table 121 in association with the status is already converted to the data record 60R associated with the member ID. In this case, the processor 11 takes No in Act 80, and then proceeds to the processing in Act 87. If the passwords are not coincident, the input password is incorrect, and thus, the processor 11 takes No in Act 81, and then proceeds to the processing in Act 87 as well.

The processor 11 controls the communication interface 14 to transmit a response command indicating a computerization error to the information terminal 30 that transmits the computerization request command in Act 87. Under this control, the communication interface 14 transmits the response command indicating the computerization error to the information terminal 30 that transmits the computerization request command. The response command indicating the computerization error transmitted from the communication interface 14 is transmitted to the information terminal 30 via the network 50 and the base station 40. Thus, an image indicating that the computerization request is not accepted is displayed on the display device of the information terminal 30 that transmits the computerization request command.

The processor 11 that controls the transmission of the response command then returns to the standby state in Act 75 and Act 76.

If the processor 11 detects that the termination button B2 is touched in the standby state in Act 75 and Act 76, the processor 11 proceeds to the processing in Act 56 in FIG. 11. Thereafter, the processor 11 executes the same processing as the processing in Act 56 to Act 62 described above. Therefore, in the processing in Act 82 to Act 85, a data record 60R stored in the first database 60 in association with the member ID in the data record 70R including the management code managed in the management table 121 is a target record to be extracted from the first database 60 to generate the receipt list image. Therefore, the electronic receipt member can view the electronic receipt as the receipt relating to the transaction in which the computerization request is made.

Here, in the electronic receipt system 100, in the POS terminal 21 which is an embodiment of a transaction processing apparatus for processing a transaction, the computer having the processor 211 as the central component executes the processing in Act 3 and Act 4 in cooperation with the keyboard 217 to function as a receiving module. The above computer executes the processing in Act 29 in cooperation with the communication interface 215 to function as a transmission module. The above computer executes the processing in Act 22 and Act 32 in cooperation with the printer 220 to function as an issuing module, and executes the processing in Act 28, Act 30 and Act 32 in cooperation with the printer 220 to function as a notifying module.

On the other hand, in the electronic receipt server 10 which is an embodiment of a management apparatus, the computer having the processor 11 as the central component executes the processing in Act 47 and Act 48 in cooperation with the second database 70 to function as a first storage module. The above computer executes the processing in Act 71 to Act 77 in cooperation with the communication interface 14 to function as an acquiring module. The above computer executes the processing in Act 82 to Act 85 in cooperation with the first database 60 to function as a second storage module. The above computer executes the processing in Act 60 and Act 61 in cooperation with the communication interface 14 to function as an output module.

As described above, the electronic receipt system 100 according to the present embodiment includes the first storage module, the notifying module, the acquiring module, the second storage module and the output module, and thus, the electronic receipt member can receive the electronic receipt later for a transaction in which only the receipt RE200 is received in the past. Therefore, even if the electronic receipt member forgets the information terminal 30 and cannot receive the electronic receipt, by using the management code and the password printed on the receipt RE200 issued in the transaction, the electronic receipt member can receive the electronic receipt as the receipt relating to the transaction. Similarly, at the time of executing the transaction, after a customer who is not the electronic receipt member becomes the electronic receipt member and is assigned with a member ID, by using the management code and the password printed on the receipt RE200 issued in the transaction, the customer can also receive the electronic receipt as the receipt relating to the transaction.

Since the electronic receipt system 100 of the present embodiment has the receiving module, the receipt data stored in association with the management code in the first storage module is limited to data relating to a transaction in which an instruction input for instructing to store the receipt data in association with the management code is received. Therefore, a storage capacity of the second database 70 can be saved. A communication traffic amount between the POS terminal 21 and the electronic receipt server 10 can also be saved.

In the electronic receipt system of the present embodiment, the management code and password are printed on the receipt RE200 to provide the management code and the password to the customer. Therefore, the customer can grasp the management code and the password used for receiving the electronic receipt having the same contents as the receipt 200 from the receipt RE200. The customer can easily recognize that the electronic receipt can be received later for a transaction in which the receipt RE200 on which the management code and the password are printed is issued.

### Second Embodiment

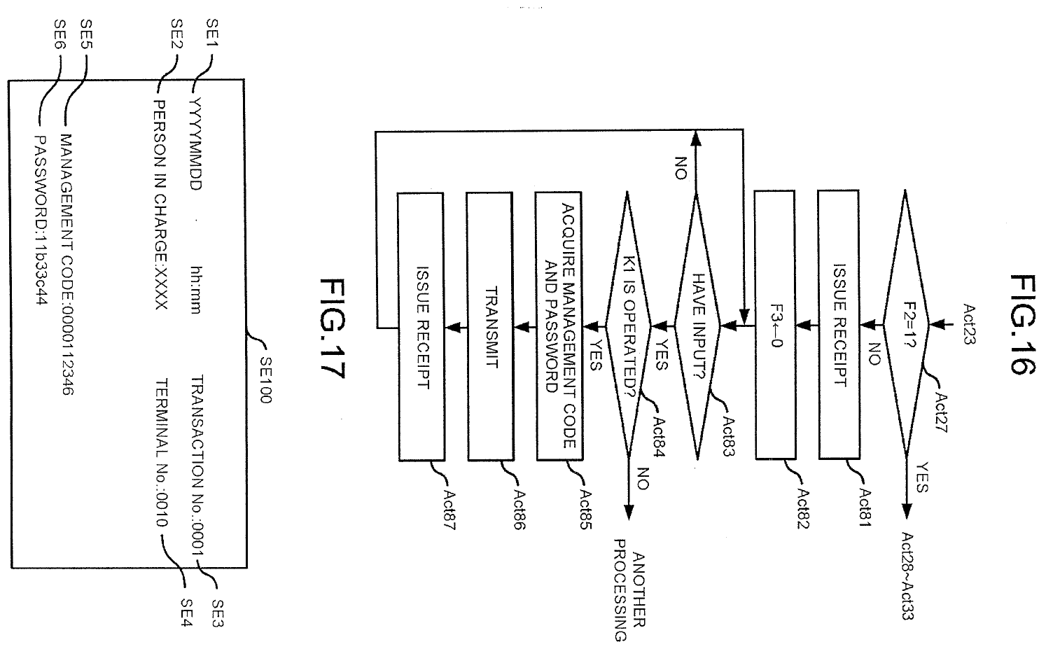

In the first embodiment, the post-issuance key K1 is operated only before the closing key is operated. Therefore, it is impossible to handle the case in which the customer requests reception of the electronic receipt after the receipt RE100 is issued. Therefore, the second embodiment in which the electronic receipt can be received even after the receipt RE100 is issued is described with reference to FIG. 16 and FIG. 17. The parts common to the first embodiment are denoted with the same reference symbols, the description thereof is omitted.

FIG. 16 shows a change in the data processing performed by the processor 211 of the POS terminal 21 as compared with the first embodiment. Specifically, FIG. 16 shows the processing after the processor 211 proceeds to the processing in Act 27 since the electronic receipt flag F1 is reset to “0” in Act 23 in FIG. 9. The processor 211 checks the post-issuance flag F2 in Act 27. If the post-issuance flag F2 is set to “1”, i.e., if the post-issuance key K1 is operated before the closing key is operated, the processor 211 executes the processing in Act 28 to Act 33 in FIG. 9 in the same manner as in the first embodiment.

On the other hand, if the post-issuance flag F2 is reset to “0”, i.e., if the post-issuance key K1 is not operated before the closing key is operated, the processor 211 takes No in Act 27, and then proceeds to the processing in Act 81. The processor 211 outputs the receipt data to the printer 220 to control printing of the receipt in Act 81. Under this control, the printer 220 prints, for example, the receipt RE100 having the layout shown in FIG. 13 on a receipt paper and issues the printed receipt RE100.

After the printing control of the receipt RE100 is performed, the processor 211 proceeds to the processing in Act 82. The processor 211 resets the transaction in-execution flag F3 to “0” in Act 82. Thereafter, the processor 211 stands by until an input is received from the input device in Act 83. The input device is the keyboard 217, the scanner 219, the card reader 221 or the like.

If an input is received from the input device, the processor 211 takes Yes in Act 83, and then proceeds to the processing in Act 84. The processor 211 determines whether or not the input is an input performed through operating the post-issuance key K1 in Act 84. Here, if the input is not the input performed through operating the post-issuance key K1, the processor 211 takes No in Act 84, and then executes another processing. Another processing is processing based on the input data.

If the processor 211 detects that the post-issuance key K1 is operated, the processor 211 takes Yes in Act 84, and then proceeds to the processing in Act 85. The processor 211 generates the management code and the password in Act 85. Then, the processor 211 controls the communication interface 215 to transmit the management code, the password and the receipt data generated in Act 22 to the electronic receipt server 10 in Act 86. Under this control, the communication interface 215 transmits the electronic receipt post-issuance data to the electronic receipt server 10.

After the electronic receipt post-issuance data is transmitted, the processor 211 proceeds to the processing in Act 87. The processor 211 controls the printer 220 to print a sheet on which the management code and the password are recorded together with identification data for identifying the receipt RE100. Under this control, the printer 220 prints, for example, a sheet SE100 having a layout shown in FIG. 17 on a receipt paper and issues it. On the sheet SE100, a transaction date and time SE1, a name of person in charge SE2, a transaction number SE3 and a terminal number SE4 are printed as the identification data for identifying the receipt RE100. A management code SE5 and a password SE6 are also printed on the sheet SE100. After the sheet SE is issued, the processor 211 returns to the processing in Act 83.

As described above, in the second embodiment, even after the receipt RE100 is issued, before a next transaction is started, by operating the post-issuance key K1, the processing in Act 85 to Act 87 is performed. By executing the processing in Act 85 to Act 87, the receipt data of the transaction added with a unique management number and a password is transmitted to the electronic receipt server 10. The sheet SE100 on which the management number and the password are printed is issued. Therefore, the electronic receipt member can receive the electronic receipt for the past transaction by inputting the management number and the password printed on the sheet SE100 in the receipt computerization menu as in the first embodiment. Here, on the sheet SE100, together with the management number and the password, the transaction date and time SE1, the name of person in charge SE2, the transaction number SE3 and the terminal number SE4 capable of identifying the receipt RE100 are printed. Therefore, although the receipt RE100 and the sheet SE100 are separately issued, the relationship therebetween can be collated from the printed contents.

### Other Embodiments

The embodiments of the electronic receipt system capable of receiving the electronic receipt for the past transaction are described above; however, the present invention is not limited thereto.

The POS terminal 21 generates the management code and the password in the above embodiments; however, the POS terminal 21 may not necessarily generate the management code and the password. For example, the management code and the password may be generated by the POS server 22, and then acquired by the POS terminal 21 via the network 24. Alternatively, the management code and the password may be generated by the electronic receipt server 10, and then acquired by the POS terminal 21 via the network 50 and the network 24.

The password is not necessarily required. Even if there is only the management code, an operation and effect of the present embodiment can be achieved as well.

In the above embodiment, the post-issuance key K1 is described as a module for receiving an input for instructing to store the receipt data in association with the management code; however, the post-issuance key K1 may function as a module for receiving an input for instructing not to store the receipt data in association with the management code. In this case, in Act 27 in FIG. 9, the processor 211 takes Yes if the post-issuance flag F2 is “0”, and takes No if the post-issuance flag F2 is “1”.

In the above embodiment, only for the transaction in which the post-issuance key K1 is operated, the receipt data is added with the management code and the password and is then transmitted to the electronic receipt server 10; however, the receipt data may be added with the management code and the password and then transmitted to the electronic receipt server 10 for all transactions in which the electronic receipt flag F1 is reset to “0”. Specifically, if it is determined that the electronic receipt flag F1 is “0” in Act 23 in FIG. 9, the processor 211 executes the processing in Act 28 to Act 33. Even in such an embodiment, an electronic receipt system capable of receiving the electronic receipt for the past transaction can be also provided.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An electronic receipt system comprising:
a first storage module configured to store receipt data indicating contents of a transaction in association with a unique management code for specifying the receipt data;
a notifying module configured to provide the unique management code to a target person associated with the transaction;
an acquiring module configured to acquire (i) a member code for specifying an electronic receipt member and (ii) a management code input including the unique management code from the electronic receipt member;
a second storage module configured to store the receipt data that is stored in the first storage module in association with the unique management code acquired by the acquiring module in association with the member code acquired by the acquiring module; and
an output module configured to output a receipt image generated according to the receipt data stored in the second storage module in association with the member code included in a request for an electronic receipt in response to the request.

2. The electronic receipt system of claim 1, further comprising a receiving module configured to receive an instruction input for instructing to store or not store the receipt data in association with the unique management code.

3. The electronic receipt system of claim 2, wherein if the instruction input for instructing to store the receipt data is received, or if the instruction input for instructing to not store the receipt data is not received, the first storage module and the notifying module are enabled.

4. The electronic receipt system of claim 3, wherein if the instruction input for instructing to store the receipt data is not received, or if the instruction input for instructing to not store the receipt data is received, the first storage module and the notifying module are disabled.

5. The electronic receipt system of claim 2, further comprising an issuing module configured to issue a receipt based on the receipt data.

6. The electronic receipt system of claim 5, wherein the notifying module provides the unique management code by recording the unique management code on the receipt issued by the issuing module.

7. The electronic receipt system of claim 5, wherein if the instruction input for instructing to store the receipt data in association with the unique management code is received by the receiving module after the receipt is issued by the issuing module, the first storage module and the notifying module are enabled, and the notifying module provides the unique management code by issuing a sheet on which the unique management code is recorded together with identification data for identifying the receipt.

8. An electronic receipt system comprising:
a transaction processing apparatus for processing a transaction, the transaction processing apparatus comprising:
a transmission module configured to transmit receipt data indicating contents of the transaction to a management apparatus; and
a notifying module configured to provide a unique management code to a target person associated with the transaction; and
the management apparatus comprising:
a first storage module configured to store the receipt data in association with the unique management code;
an acquiring module configured to acquire (i) a member code for specifying an electronic receipt member and (ii) a management code input including the unique management code from the electronic receipt member;
a second storage module configured to store the receipt data that is stored in the first storage module in association with the unique management code acquired by the acquiring module in association with the member code acquired by the acquiring module; and
an output module configured to output a receipt image generated according to the receipt data stored in the second storage module in association with the member code included in a request for an electronic receipt in response to the request.

9. The electronic receipt system of claim 8, further comprising a receiving module configured to receive an instruction input for instructing to store or not store the receipt data in association with the unique management code.

10. The electronic receipt system of claim 9, wherein if the instruction input for instructing to store the receipt data is received, or if the instruction input for instructing to not store the receipt data is not received, the first storage module and the notifying module are enabled.

11. The electronic receipt system of claim 10, wherein if the instruction input for instructing to store the receipt data is not received, or if the instruction input for instructing to not store the receipt data is received, the first storage module and the notifying module are disabled.

12. The electronic receipt system of claim 9, further comprising an issuing module configured to issue a receipt based on the receipt data.

13. The electronic receipt system of claim 12, wherein the notifying module provides the unique management code by recording the unique management code on the receipt issued by the issuing module.

14. The electronic receipt system of claim 12, wherein if the instruction input for instructing to store the receipt data in association with the unique management code is received by the receiving module after the receipt is issued by the issuing module, the first storage module and the notifying module are enabled, and the notifying module provides the unique management code by issuing a sheet on which the unique management code is recorded together with identification data for identifying the receipt.

15. An electronic receipt system comprising:
a point of sales system configured to process a transaction, the point of sales system comprising:
a scanner configured to scan code symbols associated with one or more items included in the transaction;
a printer configured to print a receipt for the transaction including at least one of (i) receipt data regarding the one or more items included in the transaction or (ii) a management code associated with the receipt data for the transaction; and
a first communications interface configured to facilitate transmitting the receipt data;
a server connected to the point of sales system, the server comprising:
a database configured to store the receipt data and the management code associated with the receipt data for the transaction;
a second communications interface configured to:
receive the receipt data from the point of sales system for storage in the database; and
receive a request from a user device for an electronic receipt, the request including the management code; and
a processor configured to generate a receipt image of the electronic receipt including the receipt data associated with the management code received in the request;
wherein the communications interface is configured to transmit the receipt image of the electronic receipt to the user device.

16. The electronic receipt system of claim 15, wherein the point of sales system further comprises an input device configured to receive a command to store the receipt data in the server for future electronic access.

17. The electronic receipt system of claim 16, wherein the printer is configured to include the receipt data and the management code on the receipt in response to the input device receiving the command prior to the receipt being printed.

18. The electronic receipt system of claim 16, wherein the printer is configured to include only the receipt data on the receipt in response to the input device receiving the command after the receipt is printed, and wherein the printer is configured to print a separate sheet on which the management code is recorded together with identification data for identifying the receipt in response to the command being received after the receipt is printed.
